(19) United States
(12) Patent Application Publication
(10) Pub. No.: US 2007/0097314 A1
(43) Pub. Date: May 3, 2007

(54) Process for the fabrication of optical microstructures

(75) Inventors: Reinhold Wimberger-Friedl, Eindhoven (NL); Johan Gerrit De Bruin, Eindhoven (NL); Emile Johannes Karel Verstegen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindoven (NL)

(21) Appl. No.: 10/582,578

(22) PCT Filed: Dec. 10, 2004
(86) PCT No.: PCT/IB04/52760

§ 371 Date: Jun. 12, 2006

(30) Foreign Application Priority Data
Dec. 16, 2003 (EP) 03104716.0

(51) Int. Cl. G02C 7/02

(52) U.S. Cl. 351/159

(57) ABSTRACT

The invention relates to a process for the fabrication of a polymeric optical microstructure, being supported or not by a substrate, starting from a thermoplastic polymer, wherein a thermoplastic polymer is blended with an UV curable resin and a thermally stable photo-initiator, to obtain a blend having a lower viscosity than the viscosity of said polymer, said blend being molded and the molded blend being cured by means of UV radiation to obtain a polymeric optical micro structure. Such a process prevents the common problems, which arise with molding of conventional thermoplastic polymers and conventional UV curing when only one of the components of the blend is used.

The invention relates to a process for the fabrication of a polymeric optical microstructure, being supported or not by a substrate, starting from a thermoplastic mixture. Optical microstructures are fabricated by molding a polymeric material and curing this molded material.

For the precise replication of the shape of a master, a good flow of the polymer material is required. The polymeric material of first choice has usually been a thermoplastic polymer; such a polymer can be processed by means of injection or compression molding.

Injection molding, nevertheless, only allows the replication of optical surfaces in combination with a thick layer (substrate). The layer thickness of the microstructure to be fabricated is, by using the injection molding technique, limited to several tenths of a millimeter, even for small areas. Further, thermoplastic polymers have a high viscosity in the molten state. It is therefore necessary to use a high pressure in injection molding, which thus leads to high forces exerted on the mold and possible brittle inserts, consisting of glass or silicon, for example. This will in turn result in damage or complete failure of these inserts, and is also a problem for making thin films.

An advantage of using thermoplastic polymers is their relatively small shrinkage only due to their high thermal expansion coefficient, compared to that of inorganic (substrate) materials. This difference is typically of the order of 0.5%.

For the replication on large surfaces, i.e. on a wafer scale, a good flow of the polymeric starting material is required. Another requirement is a low shrinkage during vitrification to minimize stresses and shape deviations between master mold and produced product.

It is observed that UV curable resins usually have good flow properties in molten condition, but have the disadvantage of a relatively high shrinkage during polymerization, which will result in shape deviations between the mold and the produced product. Such shape deviations can be corrected by adopting the mold design iteratively. This is however a difficult process and only possible for not too complicated designs. It, generally, increases the cost and development time of a component.

Further, a large shrinkage will inherently induce stresses in the obtained polymerized product. When the produced product comprises (or is made on) a thin substrate, which does not shrink, the stresses induced in the polymer may result in an unacceptable bending of the substrate.

The present invention eliminates the drawbacks of the use of thermoplastic polymers, on the one hand, and of UV curable resins, on the other hand, simply by using a combination of these materials.

The thermoplastic polymer present in the blend used in the present process, moreover, dissolves the UV-curable resin, without reacting with said resin in an appreciable level. Because the viscosity of the blend is lower than the viscosity of the thermoplastic polymer, the blend can be molded by injection molding, but at a much lower pressure so that a (thin) substrate will not be damaged, and even a glass substrate/mold can be used.

It is an object of the invention to provide a process as defined in the opening paragraph, which process allows the replication of optical surfaces without a limitation of the layer thickness, and can moreover be used with any substrate.

This object is attained with a process as defined in claim 1.

The advantage of the present process is that it can be executed at much lower temperature than the injection molding of conventional thermoplastics or the thermosetting resins, because the polymerization reaction is a photo polymerization reaction. The polymer network will be formed by the UV curable resin, while the main function of the thermoplastic polymer will be the dilution of the (reactive) system and thus does not take part in the building of the polymer network. Moreover, lower pressures than used in injection molding can be used.

The thermoplastic polymer is preferably a polymer having a weight-average molecular weight from 0.3 to 5 times the critical molecular weight for entanglement, M_{cr}, more preferably from 0.5 to 1.5 times M_{cr}. This measure ensures that the mechanical properties of the obtained product remain good and still the viscosity of the mixture is within an acceptable range. Some examples of these polymers are recited in claim 6.

The thermoplastic polymer, used in the present process, can of course be produced by prepolymerization of its monomeric component(s). Although it is preferred to use a non-reactive thermoplastic polymer, it was found that a polymer containing a minor amount of reactive groups, will not affect the optical microstructure fabricated by using such a polymer too much.

The concentration of the UV curable resin is preferably from 20-80 vol. %, more preferably from 40-60 vol. % of the blend. The lower limit of the range, i.e. 20 vol. %, is preferred when thick-walled structures must be fabricated, because in such cases it is important to obviate the shrinkage reduction during polymerization as far as possible whereas viscosity constraints are less stringent. The upper limit of the range, i.e. 70-80 vol. %, is preferred when thin-walled structures are fabricated or when very vulnerable substrates are used.

Preferred UV curable resins are defined in claims 8 and 9.

The UV curing will be started by the absorption of light by the photo-initiator present in the blend; this process thus corresponds with known UV curing processes. The curing reaction results in an increase of the molecular weight of the resin, which may result in phase separation from the polymer. To eliminate possible negative effects thereof, a blend is used wherein the components have a reasonably matched refractive index.

The thermoplastic polymer and the UV curable resin have, therefore, preferably a substantially similar refractive index.

The substrate used in the present process may consist of metal, polymer, silicon, glass or quartz.

The invention further relates to the use of a blend of a thermoplastic polymer, a UV curable resin and a thermally stable photo-initiator in the fabrication of an optical layer having a thickness to diameter ratio of from 1/50 to 1/1000, preferably 1/100.

It is in this respect observed that for injection molding the flow pathway is an important measure, which is the thickness of the layer divided by the diameter of the layer. The thinner the layer is, the smaller this ratio will be, which means that it will become more difficult to subject a composition to injection molding when a thinner layer must be made. The benchmark for injection molding is more specifically the production of a layer having a thickness of 0.6 mm and a diameter of 120 mm; such a layer can still be made by injection molding but it requires special process conditions to achieve optical quality. This ratio is not independent of the thickness for injection molding. The maximum diameter reduces faster than the thickness. Practically, thicknesses below 0.2 mm are only realized locally with a length of a few times the thickness only, e.g. on top of a thicker substrate.

These disadvantages can now be obviated by curing the present blend by means of UV radiation, and by using the UV curable resin as a solvent for the thermoplastic polymer.

Preferred embodiments of the present use are defined in claims 13 to 15.

The above and other aspects of the invention will be apparent from and elucidated with reference to the following description and by way of the non-limitative examples and drawings.

### IN THE DRAWINGS

FIG. 1 shows the ratio of the viscosity of pure PMMA and the viscosity of the PMMA/DGEBA blend vs. the concentration of DGEBA in vol. %.

FIG. 2a shows a DSC trace of 50 vol. % blend of PMMA and DGEBA during a sequence of heating and cooling and curing.

FIG. 2b shows the reaction enthalpy during curing of the blend of FIG. 2a, wherein delta H is the reaction enthalpy per gram of the blend.

FIG. 3 is a photograph of a part made from a (50:50 wt %) PMMA-DGEBA blend, molded at 70° C., UV cured at ambient temperature.

Replication of optical surface structures and lens correction layers is an important technology.

Whereas injection molding only allows the replication of optical surfaces in combination with a thick substrate, UV polymerization does not limit the layer thickness and can be applied on any substrate. For the replication of structures with large height differences, nevertheless, UV polymerization suffers from the high polymerization shrinkage of up to 10% for acrylates like hexylenediol-diacrylate (HDDA) and still over 2% for epoxides, like diglycidylether of bisphenol-A (DGEBA). This leads to shape deviations between the mold and the product. Such shape deviations can be corrected for by adopting the mold design iteratively. This, however is a difficult process and only possible in the case of simple shapes. Generally, it increases the cost and development time of a component and gives rise to a variation of product performance.

With the migration of the UV-replication technology to large substrates there is another problem arising from the large shrinkage, that is the stresses which are induced by it. Since the substrate does not shrink the polymer will end up in a tensile stress that leads to bending of the substrate which cannot be tolerated.

Generally, there is a strong demand for materials which show less shrinkage during vitrification.

Thermoplastic polymers which can be processed by injection molding and embossing suffer from their high viscosity in the molten state. The high pressure leads to high forces on the mold and insert and will lead to damage or complete failure of the brittle inserts, like glass or silicon. The layer thickness is limited to several tenths of a millimeter even for small areas. Thermoplastic polymers show a relative shrinkage during cooling from the mold temperature to ambient due to their higher thermal expansion coefficient as compared to that of the inorganic substrate and mold materials. This shrinkage is typically of the order of 0.5% (ΔT*Δα).

According to the invention, a blend of a thermoplastic polymer and a UV curable resin is used, which blend eliminates the problem of shrinkage, and also eliminates the limited flow length and high molding pressure.

For the processing of the blends of thermoplastic polymers and reactive solvents (monomers) it is desirable to have a system with a low vitrification temperature (before curing). The vitrification of a polymer solution effectively occurs at the glass-to-rubber transition. The temperature at which this transition occurs (i.e. Tg) depends on the composition and the glass transition temperatures of the individual components according to the Fox relation or more accurately the Couchman equation (see P. R. Couchman, Polym. eng. Sci., 24, 135 (1984)):

$$ln {T}_{g} = \frac{{X}_{1} Δ {C}_{p , 1} ln {T}_{g , 1} + {X}_{2} Δ {C}_{p , 2} ln {T}_{g , 2}}{{X}_{1} Δ {C}_{p , 1} + {X}_{2} Δ {C}_{p , 2}}$$

where Xᵢ is the volume fraction, and C_{p,i} the specific heat change at T_{g}.

The viscosity of the mixture can be described as a function of the distance between experimental temperature and T_{g}. A more than exponential increase is typically observed, following the WLF relation [Ferry, J. D., Viscoelastic Properties of Polymers, J. Wiley, N.Y., 3^{rd} ed. 1980]:

$$log ( \frac{{η}_{r}}{{η}_{0}} ) = \frac{- {C}_{1} ( T - {T}_{0} )}{{C}_{2} + T - {T}_{0}}$$

In order to reduce shrinkage, the polymer concentration must be kept as high as allowable from the processing and application point of view. The viscosity of the mixture depends on the concentration of the polymer to a high power (4^{th} or higher) and T_{g} of the constituents. It further depends on the molecular weight of the polymer, generally with more than the 3rd power of the weight-average molecular weight, M_{w}.

So a system can be selected to have the lowest possible processing temperature (room temperature processing is preferred) by choosing thermoplastic polymers with a low T_{g} and a low M_{w}.

The T_{g} of the final material will also follow the Couchman rule, in the case that no phase separation has occurred, but now the T_{g} of the reactive species must be taken in its cured state. For certain applications it is not necessary to have the final material in the glassy state as long as due to the cross-linking reaction of the monomer a network is created which behaves like a solid. The T_{g}'s of the material employed in precision applications are usually higher than 100° C., provided that they are completely cured. Therefore, the T_{g}'s of the thermoplastic polymers used in the invention are preferably not lower than 50° C. for precision applications.

It is further remarked that the T_{g} of a polymer is inversely proportional to the number average molecular weight Mₙ, while the viscosity of the polymer increases when the molecular weight of the polymer is larger than the critical molecular weight for entanglement M_{cr}. Therefore, the thermoplastic polymer to be used in the inventive process has expediently a weight-average molecular weight from 0.1 to 5 times the critical molecular weight for entanglement, M_{cr}, more preferably in the range from 0.5 to 1.5 times M_{cr}.

Some examples of thermoplastic polymers which can be used in the present invention, together with the T_{g} values thereof are given in Table 1:

TABLE 1

| Thermoplastic polymer | T_{g} (° C.) |
|---|---|
| Polymethylmethacrylate | 126° C. |
| Polyethylmethacrylate | 65° C. |
| Polyhexylmethaacrylate | −5° C. |
| Polydecylmethacrylate | −55° C. |
| Polymethylacrylate | 10° C. |
| Polyethylacrylate | −20° C. |
| Polyhexylacrylate | −58° C. |

The blend of thermoplastic polymer and UV curable resin shows a viscosity which is higher than that of the pure resin, but much lower than that of the pure polymer. Therefore the blend can be molded, similarly to injection molding but now at a low pressure so that the substrate will survive and glass molds can be used. Alternatively filling in an open mold as used in conventional UV replication is possible as well. After complete filling the UV light source is switched on, the reaction starts and proceeds leading to vitrification of the solution. After sufficient vitrification the product can be released from the mold and optionally post-cured, like conventional UV curing systems. The UV curing is started by the absorption of light by a so-called initiator which is present at low concentration exactly like in a normal UV curing process.

Initiators to be used in the present invention are preferably selected from the free radical initiators and the photo-acid generators.

Examples of free radical initiators are

α-hydroxy-ketones, such as Irgacure 184 and Darocure 1173 (both trademarks of Ciba-Geigy AG);

α-amino-ketones, such as Irgacure 907 and Irgacure 369 (both trademarks of Ciba-Geigy AG);

benzyldimethyl-ketal, such as Irgacure 651 (=DMPA:α,α-dimethoxy-α-phenyl-acetophenone) (trademark of Ciba-Geigy AG); Azobisisobutyronitrile; and

Azoesters.

The photo-acid generators can in general be divided in two groups: the diphenyliodonium salts and the triphenylsulfonium salts. Both are so-called Lewis acids. The variation mostly lies in the type of counterion. Further for the second class the amount of phenyl rings varies. Each phenyl ring is connected by another one via a sulfur bond.

An example of the first one is: Diphenyliodonium hexafluoroarsenate.

An example of the second one is: Triphenylsulfonium hexafluoroantimonate. Except for the general photo-acid generators, different salts are also possible, or a mixture of salts.

Sometimes an accelerator is added to shift the absorbance spectrum or the efficiency of the initiators. Examples are anthracene or thioxanthone.

It is observed that by using photo-initiated curing, the curing reaction can be started at any desirable moment. The curing reaction results in an increase in the molecular weight of the solvent (i.e. UV curable resin), which may result in phase separation from the polymer.

This phase separation is viscosity controlled. It can be suppressed by a fast reaction and reaction at low temperatures where the viscosity of the system is high. By the use of a blend in which the components have a reasonably matched refractive index it is not even necessary to suppress phase separation, as it will not lead to significant light scattering which would be undesirable for most optical applications.

The photo-initiator must be stable at the temperature of the molding process otherwise reaction will start before complete filling.

The UV curable resin is preferably an epoxy resin, more specifically the diglycidylether of bisphenol-A, or an acrylate or methacrylate such as ethoxylated bisphenol-A dimethylacrylate.

In general all suitable monomers of the free radical initiated type can be selected for the UV curable resin. These can be selected from among the group of acrylate and methacrylate monomers, allylic monomers, norbornene monomers, hybrid monomers thereof containing chemically different polymerizable groups and multifunctional thiol monomers, provided that said thiol is used in combination with at least one of said non-thiolmonomers; and a polymerization initiator. Preferably, at least one of said monomers, not being a thiol, is provided with at least two functional groups, which groups will take part in the polymerization process, to obtain a crosslinked polymer network. The term “multifunctional” as used here, means that the number of monomers which can be coupled per monomer is larger than 1.

Alternatively, thiol-ene systems composed of multithiols and multiallylic monomers and a (radical) polymerization initiator can be used, either separately or in combination with the above indicated (meth)acrylates. Non-limitative examples of thiols are trimethylolpropane trithiol, pentaerythritol tetrathiol and their ethoxylated homologs. Non-limitative examples of allylic monomers are the diallylic ester of isophorone diisocyanate, triallyl cyanurate and -isocyanurate and the di- and triallyl ethers of trimethylolpropane.

Also monomers polymerizing cationically can be used such as epoxides and oxetanes, as well as ortho-esters and the very fast reacting vinylethers. Moreover combinations thereof and mixtures found from monomers reacting via free radical initiation and monomers reacting cationically as well as hybrid monomers thereof are well suited, given the use of mixtures of both free radical and photoacid generators or photoinitiators enabling both free radical and acid generation.

### EXAMPLE 1

Blends of polymethylmethacrylate (PMMA) and diglycidylether of bisphenol-A (DGEBA) were prepared.

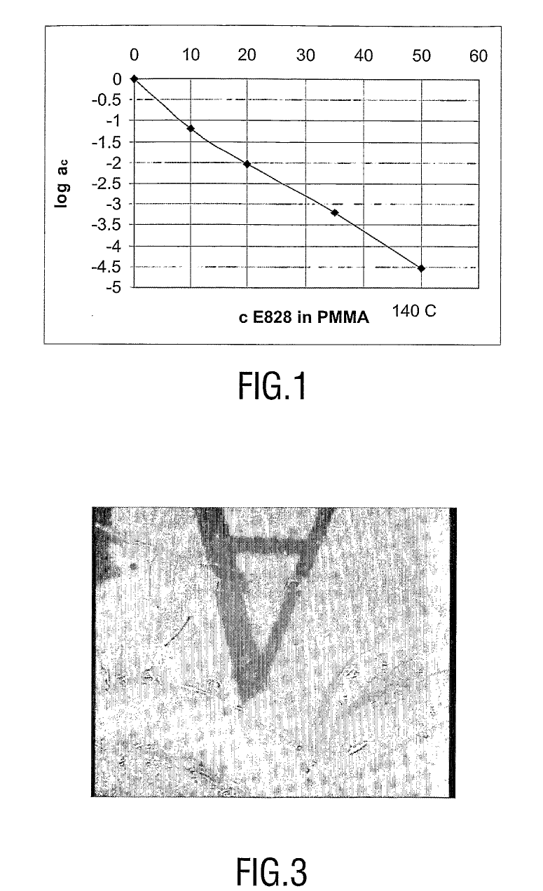

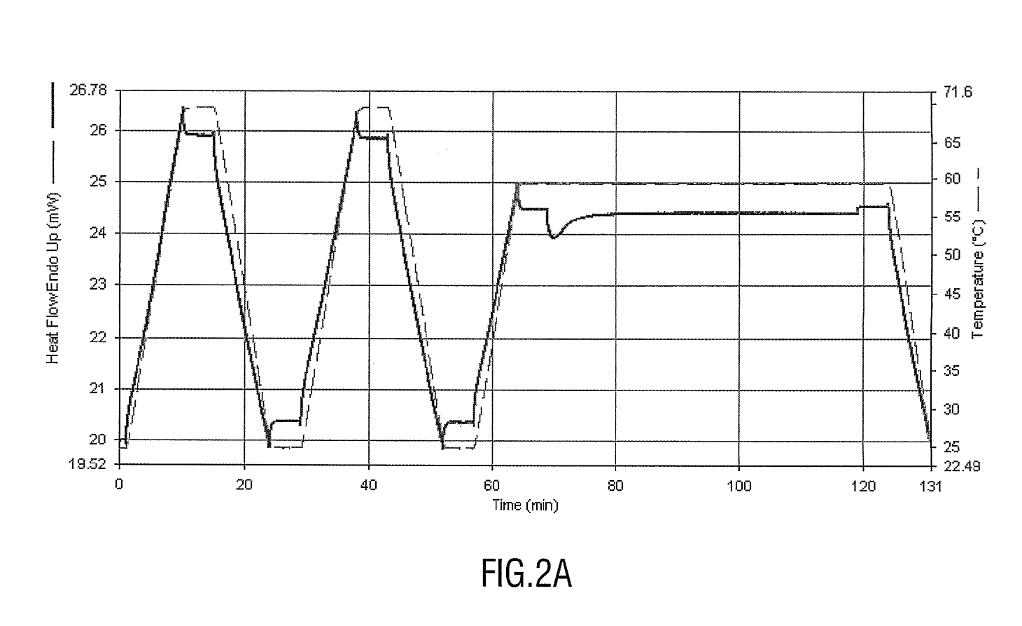

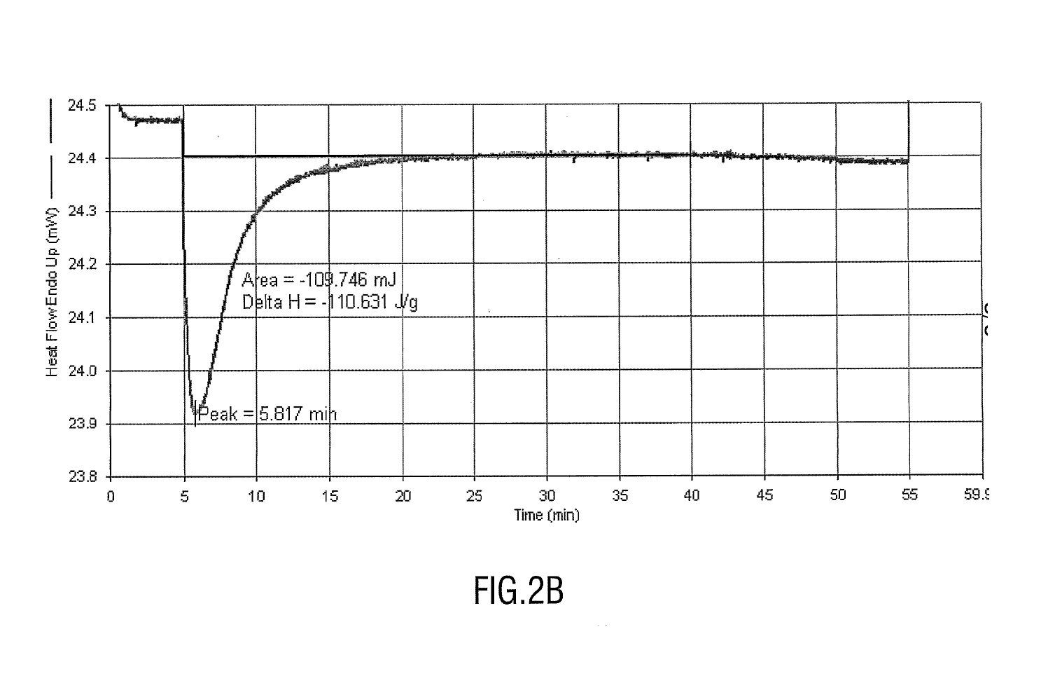

In FIG. 1 the viscosity of polymethylmethacrylate (PMMA) is depicted as a function of the concentration of diglycidylether of bisphenol-A (DGEBA) at 150° C. As can be seen the viscosity decreases by a factor of over 30,000 upon the addition of 50 vol. % reactive solvent. The blend is miscible over the entire range of composition. Upon irradiation the polymerization starts which leads to an increase in viscosity with time with the increasing conversion of the reactive solvent. In FIG. 2(a) a DSC trace is shown of a 50/50 blend of PMMA and DGEBA (containing 4.75 wt. % diphenyliodoniumhexafluorarsenate (DIHFA) and 0.25 wt. % anthracene) indicating in the first part that no reaction takes place when the mixture is heated to 70° C. but at the moment the light source is switched on at 60° C. reaction starts and proceeds fast. The reaction enthalpy can be calculated from the curve, given in FIG. 2(a), and is (enlarged) given in FIG. 2(b). From this enthalpy the conversion can be derived via the specific heat of reaction. The achieved conversion is comparable to that of a pure DGEBA system cured under comparable conditions. The material obtained in this way is transparent for visible light. A close look at a fracture surface in the Scanning Electron Microscope reveals a morphology of spheres with a diameter of less than 100 nm, indicating an onset of a phase separation of the DGEBA network and the PMMA thermoplastic. Apparently, this morphology does not induce visible scattering at a thickness of 0.2 mm as can be seen from the photograph in FIG. 3, despite the fact that the refractive indices of PMMA and DGEBA network differ by 0.008.

1. A process for the fabrication of a polymeric optical microstructure, being supported or not by a substrate, starting from a thermoplastic mixture,
wherein a thermoplastic polymer is blended with a UV curable resin and a thermally stable photo-initiator, to obtain a blend having a lower viscosity than the viscosity of said polymer, said blend being molded and the molded blend being cured by means of UV radiation to obtain a polymeric optical microstructure.

2. A process according to claim 1, wherein said thermoplastic polymer has a weight-average molecular weight from 0.1 to 5 times the critical molecular weight for entanglement, M_{cr}, more preferably in the range from 0.5 to 2 times M_{cr}.

3. A process according to claim 1, wherein said thermoplastic polymer contains a minor amount of reactive groups.

4. A process according to claim 1, wherein said thermoplastic polymer is an amorphous thermoplastic polymer.

5. A process according to claim 1, wherein said thermoplastic polymer is a copolymer or terpolymer.

6. A process according to claim 1, wherein said thermoplastic polymer is selected from the group, consisting of polymethylmethacrylate, polyethylmethacrylate, polyhexylmethacrylate, polydecylmethacrylate, polymethylacrylate, polyethylacrylate, polyhexylacrylate, polydecylacrylate, polyvinylacatate, polystyrene, poly-α-methylstyrene, poly-α-ethylstyrene, polycarbonate, polyester, cycloolefinic polymer and cyclo-olefinic copolymer.

7. A process according to claim 1, wherein the concentration of the UV curable resin is from 20-80 vol. %, more preferably from 40-60 vol. % of said blend.

8. A process according to claim 1, wherein said UV curable resin is an epoxy resin, preferably diglicidylether of bisphenol-A.

9. A process according to claim 1, wherein said UV curable resin is selected from the group of acrylates and methacrylates, preferably ethoxylated bisphenol-A dimethacrylate, hexanedioldiacrylate and polyethylenediacrylate.

10. A process according to claim 1, wherein said thermoplastic polymer and said UV curable resin show a substantially similar refractive index.

11. A process according to claim 1, wherein said substrate consists of metal, polymer, silicon, glass or quartz-glass.

12. Use of a blend of a thermoplastic polymer, a UV curable resin and a thermally stable photo-initiator in the fabrication of an optical microstructure having a thickness of at most 1 mm, preferably at most 0.5 mm.

13. Use according to claim 12, wherein said thermoplastic polymer is polymethylmethacrylate and said UV curable resin is the diglicidylether of bisphenol-A.

14. Use according to claim 12, wherein said optical microstructure is selected from the group consisting of a lens, Fresnel lens, collimator, diffractive optical element, LED window, optical storage medium and LCD back and front lighting system.

15. Use of a blend of a thermoplastic polymer, a UV curable resin and a thermally stable photo-initiator in the fabrication of a microfluidic device containing internal channels with a height of typically less than 1 mm, preferably less than 0.5 mm.
